(19) United States
(12) Patent Application Publication
(10) Pub. No.: US 2012/0256094 A1
(43) Pub. Date: Oct. 11, 2012

(54) DUAL-PARTICLE IMAGING SYSTEM FOR STANDOFF SNM DETECTION IN HIGH-BACKGROUND-RADIATION ENVIRONMENTS

(76) Inventors: SARA POZZI, Ann Arbor, MI (US); Shaun Clarke, Ypsilanti, MI (US); Marek Flaska, Ypsilanti, MI (US); Alexis Poitrasson-Riviere, Ann Arbor, MI (US); Kyle Polack, Grosse Pointe Farms, MI (US); Kiyotaka Ide, Higashine (JP)

(21) Appl. No.: 13/441,242

(22) Filed: Apr. 6, 2012

Related U.S. Application Data
(60) Provisional application No. 61/472,217, filed on Apr. 6, 2011.

(51) Int. Cl. G01N 23/05; G01T 1/16; G01T 1/20

(52) U.S. Cl. 250/366; 250/390.02; 250/394

(57) ABSTRACT

A dual-particle imaging system of the present teachings provide for standoff, passive detection of special nuclear material. In some embodiments, the system comprises three detector planes that together are capable of imaging both photons and fast neutrons. The ability of the system to detect fast neutrons makes it more difficult to effectively shield a threat source.

### CROSS-REFERENCE TO RELATED APPLICATIONS

This application claims the benefit of U.S. Provisional Application No. 61/472,217, filed on Apr. 6, 2011. The entire disclosure of the above application is incorporated herein by reference.

### GOVERNMENT CLAUSE

This invention was made with government support under DE-NE0000324 awarded by the U.S. Department of Energy. The government has certain rights in the invention

### FIELD

The present disclosure relates to detection of nuclear material and, more particularly, relates to a dual-particle imaging system for standoff special nuclear material (SNM) detection in high-background-radiation environments.

### BACKGROUND AND SUMMARY

This section provides background information related to the present disclosure which is not necessarily prior art. This section provides a general summary of the disclosure, and is not a comprehensive disclosure of its full scope or all of its features.

Stockpiles of SNM exist worldwide. SNM, which includes ²³⁹Pu, ²³³U, and uranium enriched to higher than 20% of ²³⁵U, can have both weapons and peaceful applications. Thus, SNM must be monitored to prevent its diversion for weapons applications. To aid in this effort, a variety of tools have been developed to help monitor, detect, and characterize different radioactive sources. These systems take advantage of various materials and detection techniques, each having their own advantages and disadvantages.

Radiation imaging systems are of particular interest because they are capable of detecting and localizing radioactive sources. Traditional Compton-camera systems detect photons and have been commonly used for many years in several applications, including medical imaging and nuclear security. Neutron-scatter cameras have also been part of recent research efforts for use in nuclear-security applications. However, high-Z materials can effectively shield photons and low-Z materials can effectively shield neutrons. This allows for detection systems sensitive to a single particle type to be easily foiled by relatively simple shielding geometries.

This disclosure presents a dual-particle imaging system that overcomes the disadvantages of the prior art by combining a traditional Compton-camera system with a neutron-scatter camera system to detect and image both photons and fast neutrons. In some embodiments, the system of the present teachings utilizes two planes of EJ-309 liquid scintillators and one plane of NaI scintillators, which allows for detection and imaging of both photons and fast neutrons. The present teaching further provides advanced features, such as moveable detecting planes that can be actively, passively, automatically, or otherwise moved to detect a source, track a source, and/or improve the overall efficiency of the system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view illustrating the principles of source localization for a two-plane, Compton-camera system;

FIG. 2 is a schematic view illustrating a neutron-scatter interaction;

FIG. 3A is a schematic view illustrating a three-plane, dual-particle imager with two imageable interaction sequences shown according to the principles of the present teachings;

FIG. 3B is a schematic view illustrating a moveable front and back plane according to the principles of the present teachings;

FIG. 3C is a schematic view illustrating a three-plane, dual-particle imager according to the principles of the present teachings;

FIG. 3D is a graph illustrating the pulse-shape discrimination of neutrons from gamma rays for an EJ-309 liquid scintillation detector using an optimized, digital, charge-integration technique;

FIG. 4 is a photograph of various Scionix EJ-309 and NaI detectors using in accordance with the present teachings;

FIG. 5 is a schematic view illustrating a three-plane, dual-particle imager used for simulating the measurement of bare and shielded ²⁵²Cf;

FIG. 6A is a simple-backprojection image and a side view of a hot-spot peak for combined neutron and photon interactions using an unshielded ²⁵²Cf point source of approximately 80,000 fissions per second;

FIG. 6B is a simple-backprojection image and a side view of a hot-spot peak for neutron interactions using an unshielded ²⁵²Cf point source of approximately 80,000 fissions per second;

FIG. 6C is a simple-backprojection image and a side view of a hot-spot peak for photon interactions using an unshielded ²⁵²Cf point source of approximately 80,000 fissions per second;

FIG. 7A is a simple-backprojection image and a side view of a hot-spot peak for combined neutron and photon interactions using a ²⁵²Cf point source of approximately 80,000 fissions per second shielded by 5.08 cm of lead;

FIG. 7B is a simple-backprojection image and a side view of a hot-spot peak for neutron interactions using a ²⁵²Cf point source of approximately 80,000 fissions per second shielded by 5.08 cm of lead;

FIG. 7C is a simple-backprojection image and a side view of a hot-spot peak for photon interactions using a ²⁵²Cf point source of approximately 80,000 fissions per second shielded by 5.08 cm of lead;

FIG. 8A is a simple-backprojection image and a side view of a hot-spot peak for combined neutron and photon interactions using a ²⁵²Cf point source of approximately 80,000 fissions per second shielded by 5.08 cm of polyethylene;

FIG. 8B is a simple-backprojection image and a side view of a hot-spot peak for neutron interactions using a ²⁵²Cf point source of approximately 80,000 fissions per second shielded by 5.08 cm of polyethylene;

FIG. 8C is a simple-backprojection image and a side view of a hot-spot peak for photon interactions using a ²⁵²Cf point source of approximately 80,000 fissions per second shielded by 5.08 cm of polyethylene;

FIG. 9A is a simple-backprojection image and a side view of a hot-spot peak for combined neutron and photon interactions using a ²⁵²Cf point source of approximately 80,000 fissions per second shielded by 5.08 cm of lead followed by 5.08 cm of polyethylene;

FIG. 9B is a simple-backprojection image and a side view of a hot-spot peak for neutron interactions using a ²⁵²Cf point source of approximately 80,000 fissions per second shielded by 5.08 cm of lead followed by 5.08 cm of polyethylene;

FIG. 9C is a simple-backprojection image and a side view of a hot-spot peak for photon interactions using a ²⁵²Cf point source of approximately 80,000 fissions per second shielded by 5.08 cm of lead followed by 5.08 cm of polyethylene;

FIG. 10 is a photograph of a measurement setup used for the neutron-scatter camera validation measurement with a plane spacing of 10 cm;

FIG. 11A is a simple-backprojection image of a ²⁵²Cf source of approximately 11,000 fissions per second located 50 cm from the neutron-scatter camera, where data were gathered through simulation;

FIG. 11B is a simple-backprojection image of a ²⁵²Cf source of approximately 11,000 fissions per second located 50 cm from the neutron-scatter camera, where data was gathered through measurement;

FIG. 11C is a reconstructed neutron energy spectrum for the measurements of FIG. 11B;

FIG. 12 is a photograph of a measurement setup used for the Compton-camera validation measurement with a plane spacing of 10 cm;

FIG. 13A is a simple-backprojection image of a ²²Na source of approximately 30-uCi (3×10⁶ photons per second) located 50 cm from the Compton camera and offset by 30 cm, where data were gathered via simulation;

FIG. 13B is a simple-backprojection image of a ²²Na source of approximately 30-uCi (3×10⁶ photons per second) located 50 cm from the Compton camera and offset by 30 cm, where data were gathered via measurement;

FIG. 13C is a reconstructed photon energy spectrum for the measurements of FIG. 13B, with the window indicating the energy range used in creating the backprojection image; and

FIGS. 14A-14C is a series of simple backprojection images and side views for 2-MeV incident neutrons detected with planes of three different separation distances with 0 separation, a 6-inch separation, and 12-inch separation, respectively.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

I. Dual-Particle Imager System

The dual-particle imager system 10 of the present teachings is based on the physics of Compton and neutron scatterings. It is capable of simultaneously utilizing information gathered from both photon and neutron interactions in the system 10 to produce a single, combined visualization of a measured source distribution.

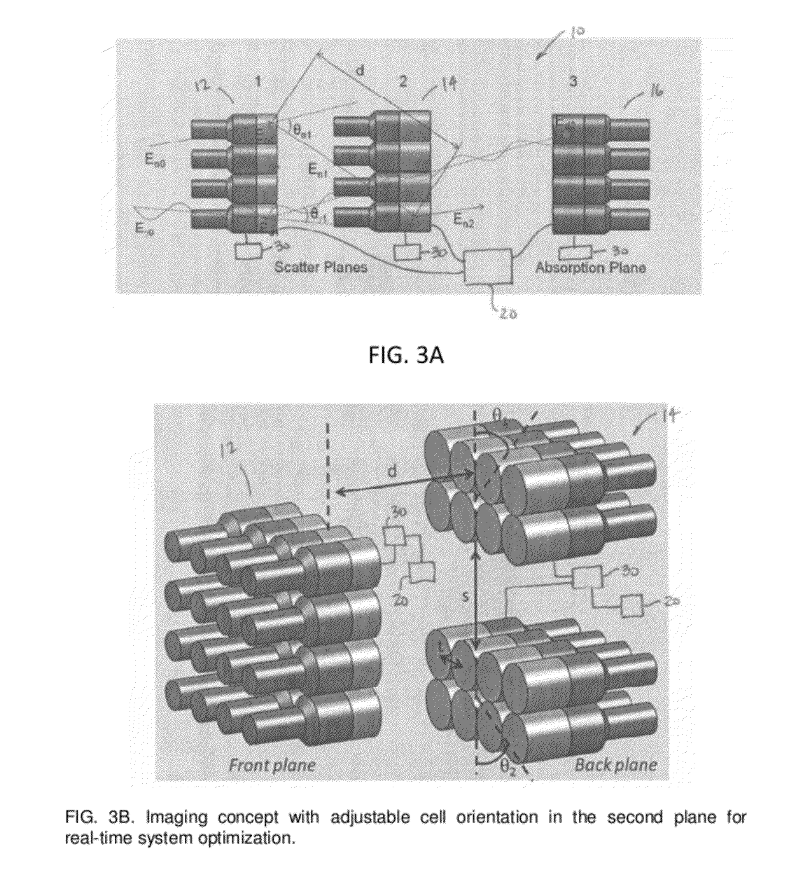

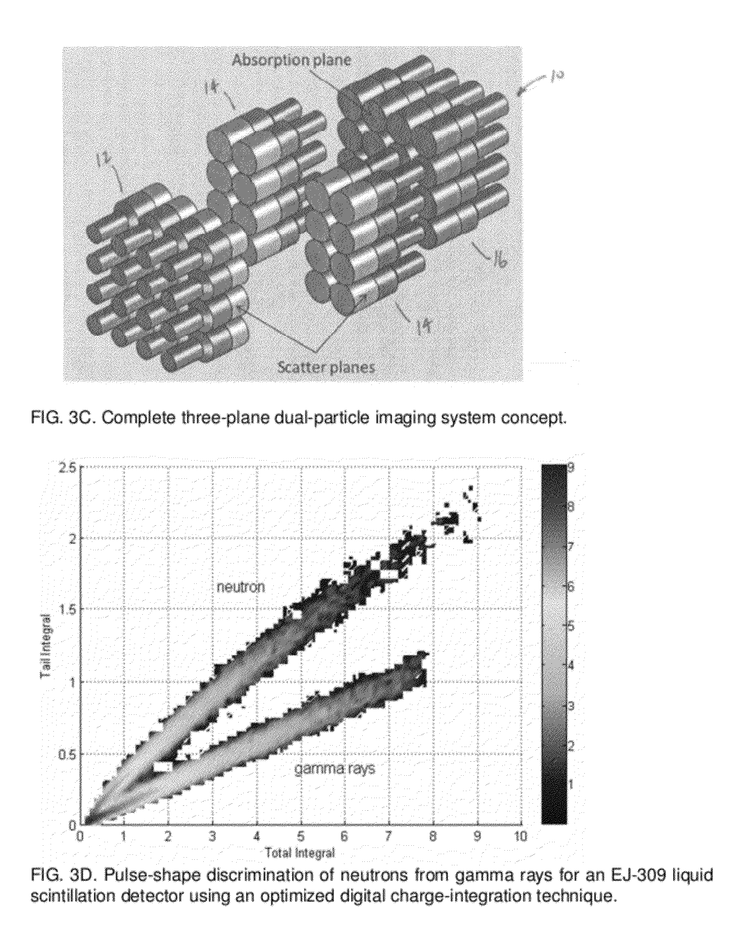

More particularly, dual-particle imager system 10 of the present teachings provide for standoff, passive detection of SNM. In some embodiments, the system 10 comprises three detector planes that together are capable of imaging both photons and fast neutrons. The ability of the system to detect fast neutrons makes it more difficult to effectively shield a threat source. This feature has an advantage over the commonly used Compton-camera systems, which are only sensitive to photons. Additionally, the detection of fast neutrons will allow for increased performance in regions with high depositions of photon-background radiation. In some embodiments, the first two planes of the system consist of EJ-309 liquid scintillators and the third plane consists of NaI scintillators. This detector/plane combination allows image reconstruction using both photons and fast neutrons. In the liquid scintillators, neutron interactions are distinguished from photon interactions using an optimized pulse-shape discrimination technique, as illustrated in FIG. 3D. The Monte Carlo transport code MCNPX-PoIiMi has been used for the initial studies of this system due to its ability to track detailed information on interactions of interest and time-correlated particle production. This information has been used to optimize system parameters and has also allowed for investigation of image reconstruction techniques including simple-backprojection and maximum likelihood expectation maximization (MLEM).

A. Concept and Imaging Principle

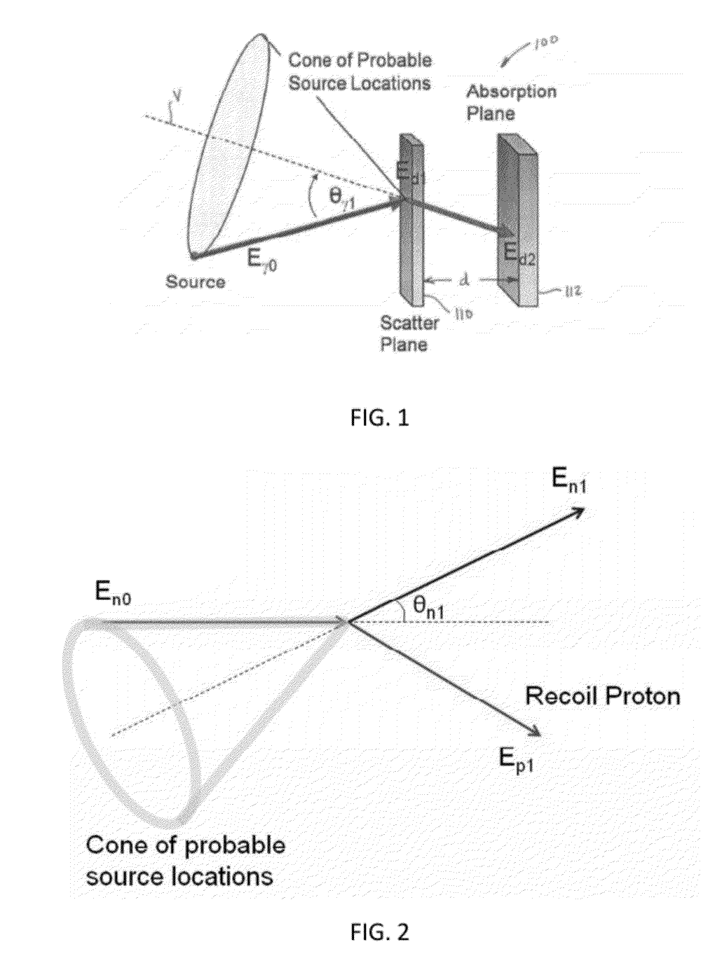

A traditional Compton imaging system 100 uses position and energy information from a photon that is scattered and subsequently absorbed to determine the incident angle of approach. Equation (1) demonstrates how the incident angle, θ_{γ1}, can be calculated based on the incident photon energy, E_{γ0}, equal to the sum of the energies deposited, E_{d1}+E_{d2} when the second interaction is an absorption, and the energy lost due to scatter, E_{d1}. The incident angle, θ_{γ1}, actually represents the opening angle of a cone that is aligned along a vector V between the photon scatter of the scatter plane 110 and absorption locations on the absorption plane 112, as shown in FIG. 1. After multiple interactions have accumulated, the cones overlap and a source location can be determined. That is, a source location can be determined by noting where the cones overlap after multiple interactions have accumulated.

$$cos {θ}_{γ 1} = 1 - \frac{{m}_{e} {c}^{2} \times {E}_{d 1}}{{E}_{d 2} ( {E}_{d 1} + {E}_{d 2} )} \qquad ( 1 )$$

A neutron-scatter camera uses the position and energy information obtained from two consecutive neutron scatters to determine the cone surface of probable source locations. Equations (2) and (3) demonstrate how the energy transferred to the recoil proton by the first scatter, Eₚ₁, and the time of flight (TOF) required to travel a distance, d, between the first scatter at scatter plane 110 and second scatter at absorption plane 112 can be used to determine the opening angle of the cone, θₙ₁. This process is depicted in FIG. 2.

$$\begin{matrix}{tan}^{2} {θ}_{n 1} = \frac{{E}_{p 1}}{{E}_{n 1}} & ( 2 ) \\ {E}_{n 1} = \frac{{m}_{n}}{2} \times \frac{{d}^{2}}{{TOF}^{2}} & ( 3 )\end{matrix}$$

In some embodiments of the present teachings, these two scattering principles may be combined into a single, three detector plane system 10 that is operable to image dual particles, namely photons and neutrons, as illustrated in FIGS. 3A-3C. To this end, dual-particle imager system 10 can comprise a first scatter plane 12, a second scatter plane 14, and an absorption plane 16. As will be discussed herein, at least first scatter plane 12 and second scatter plane 14 can be configured to move at least in inclination. The front two planes, namely first scatter plane 12 and second scatter plane 14 can be composed of a material capable of scattering both photons and neutrons, while the absorption plane 16 can absorb photons. In some embodiments, second scatter plane 14 and absorption plane 16 can be combined into a single plane. However, it should be noted that using a three-plane system in accordance with the teachings of the present invention, photons can also be imaged without undergoing photoelectric absorption. If a photon scatter is detected in each plane, the incident energy can be calculated using equation (4) with the angle θ_{γ2} calculated from the positions of the three interactions. The incident angle can then be calculated. However, the three required scattering events are less likely to be detected, because each event must be above a detection threshold. Additionally, the uncertainty on the incoming energy for a triple-scatter event is greater than for an event using only two planes, resulting in a worse angular resolution.

$${E}_{γ0} = {E}_{d 1} + \frac{\sqrt{{E}_{d 2}^{2} + \frac{4 {m}_{e} {c}^{2} {E}_{d 2}}{1 - cos {θ}_{γ 2}}} - {E}_{d 2}}{2} \qquad ( 4 )$$

B. System Components

In some embodiments, EJ-309 liquid scintillators have been chosen for use in first scatter plane 12 and second scatter plane 14. These scintillators are sensitive to both neutrons and photons and are capable of excellent pulse shape discrimination (PSD). Additionally, the high flashpoint (144° C.) of the EJ-309 liquid makes these detectors suitable for field use. In some embodiments, NaI, which is sensitive to photons (scattering and photoelectric absorption), was chosen for use in absorption plane 16 due to its high efficiency, adequate energy resolution, and relatively low cost.

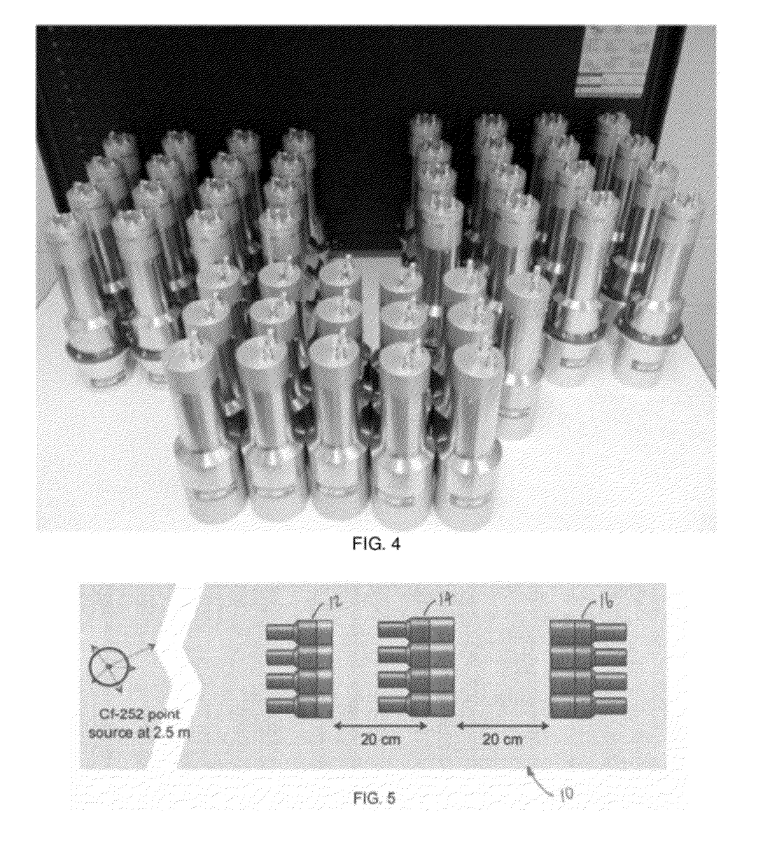

The detectors purchased for prototype development include sixteen 5.08-cm thick EJ-309 liquid scintillators for first scatter plane 12, sixteen 7.62-cm thick EJ-309 liquid scintillators for second scatter plane 14, and sixteen 7.62-cm thick NaI scintillators for absorption plane 16. All detectors are 7.62-cm in diameter and are shown in FIG. 4.

It should be noted that the dual-particle imaging system 10 can further include a central processor 20, such as a computer. The central processor 20 can be used for data collection, data analysis and imaging, system control (e.g. control of operation and/or positioning of first scatter plane 12, second scatter plane 14, and absorption plane 16). It should be recognized that elements of dual-particle imager system 10 can be used for multiple purposes to provide improved equipment and use efficiency, reduced cost, and simplified construction.

C. Moveable Planes

In some embodiments, the dual-particle imaging system 10 can comprise two or more planes of multiple detector cells (e.g. planes 12, 14), wherein one or more of the planes is moveable and/or adjustable in real-time to account for varying measurement conditions. In some embodiments, as illustrated in FIGS. 3A and 3B, the inter-planar spacing (d), the inter-group spacing (s), the detector pitch (t), and orientation angles (θ₁, θ₂) can be adjustable using an actuation system 30, such as a mechanical, pneumatic, electro-mechanical, electronic, or other adjustment mechanisms, and may be controlled, in some embodiments, by central processor 20. The adjustment of one or more of these parameters enables on-the-fly optimization of two key system-performance parameters, namely detection efficiency and angular resolution. The adjustability of the inter-group spacing, detector pitch, and orientation angles allows the system to increase detection efficiency in certain energy ranges of interest. In addition, adjustment of the inter-planar spacing allows the angular resolution to be improved at the expense of efficiency, which could also be valuable under certain measurement conditions. It should be recognized that absorption plane 16 may, in some embodiments, include an actuation system 30. However, it may not be necessary even in cases where one or more of planes 12 and 14 includes actuation system 30.

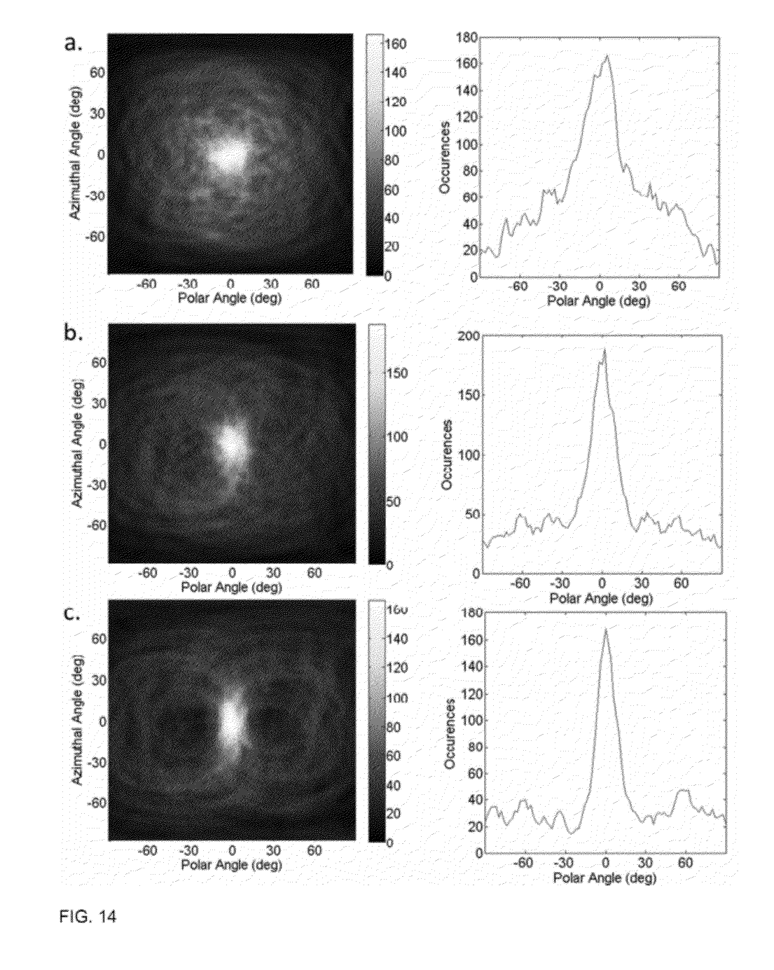

It should be understood from the foregoing that for a given incident-particle energy the probability of scattering into the second plane 14 from the first plane 12 depends on the separation between the two planes 12, 14. For this reason, it is advantageous to move the planes depending on the energy of particles incident on the system. FIGS. 14A-14C illustrate a result for 2-MeV incident neutrons detected with planes of three different separation distances: FIG. 14A was produced with no separation between the planes, FIG. 14B was produced with a 6-inch separation, and FIG. 14C was produced with a 12-inch separation. In this example the 12-inch separation produces a hotspot that is approximately twice as narrow as the case with no separation. By adjusting this separation distance (or inter-planar spacing (d), the inter-group spacing (s), the detector pitch (t), and/or orientation angles (θ₁, θ₂)), the output results can be maximized or otherwise tailored to a particular environment, source, or other characteristic.

One embodiment of the actuation system could adjust this separation in real-time, based on the incoming energy information, to produce the best localization of the source. Similar behavior is observed if one adjusts the group separation and/or angular orientation of the planes (as noted in FIG. 3B).

II. Monte Carlo Simulation

Simulations have been performed on the dual-particle imaging system 10 using the MCNPX-PoIiMi Monte Carlo code in order to help with system design and to obtain a preliminary understanding of system performance. Additionally, a post-processor, such as central processor 20, has been developed that allows both simulated and measured data to be analyzed and imaged.

A. MCNPX-PoIiMi

MCNPX-PoIiMi is a modified version of the MCNPX Monte Carlo code that is especially useful for tracking correlated events. This is done by tracking detailed information on all interactions occurring within user-defined volumes of interest. MCNPX-PoIiMi output from central processor 20 includes details such as interaction type, energy deposited by an interaction, time of interaction, and position of interaction. As discussed herein, this information can then be used to create imageable events.

B. Data Post-Processing

The information provided by a MCNPX-PoIiMi simulation can be further processed to model the uncertainties found in a realistic detector response. This includes applying a pulse-generation time to combine successive interactions, applying detector thresholds to eliminate energy depositions that would not be detected in a real measurement, and applying energy and time broadening so that energy and time resolution are consistent with the detectors being used. This information is combined and a pulse height and time stamp is generated for each pulse. This allows for the imaging portion of the post-processor to operate on both measured and simulated data alike.

III. Imaging Bare and Shielded Sources

The simulation methods described above were used to gauge the response of the dual-particle imager to a spontaneous fission source. A bare source was tested in addition to a variety of shielding configurations.

A. Simulation Geometry

The dual-particle imaging system 10 was modeled using three, sixteen-detector planes (arranged in a 4×4 array) as illustrated in FIG. 5. The front plane consisted of 5.04-cm thick EJ-309 detectors and the second plane consisted of 7.62-cm thick EJ-309 detectors. Both the first and second planes had the photomultiplier tubes (PMTs) and electronics facing towards the front of the system. The back plane consisted of 7.62-cm thick NaI scintillators with the PMTs and electronics facing towards the back of the system. An interplanar spacing of 20 cm was used and was measured as the distance between active detector materials from one plane to the next.

The source was a ²⁵²Cf point source of approximately 80,000 fissions per second. It was located 2.5 m from the dual-particle imaging system 10 with no angular offset from the centerline of the detector planes. In addition to simulating the bare point source, simulations were run using various shielded spheres surrounding the source. The shielding configurations were 5.08 cm of lead, 5.08 cm of polyethylene and 5.08 cm of polyethylene surrounded by 5.08 cm of lead. The order of the combined shielding was chosen so that the layer of lead would attenuate the 2.2-MeV photons created by neutron absorption on hydrogen. Each source-shielding configuration was simulated for the number of fissions equivalent to a twenty-minute measurement. There was no background radiation present in these simulated measurements.

B. Bare Cf Point Source

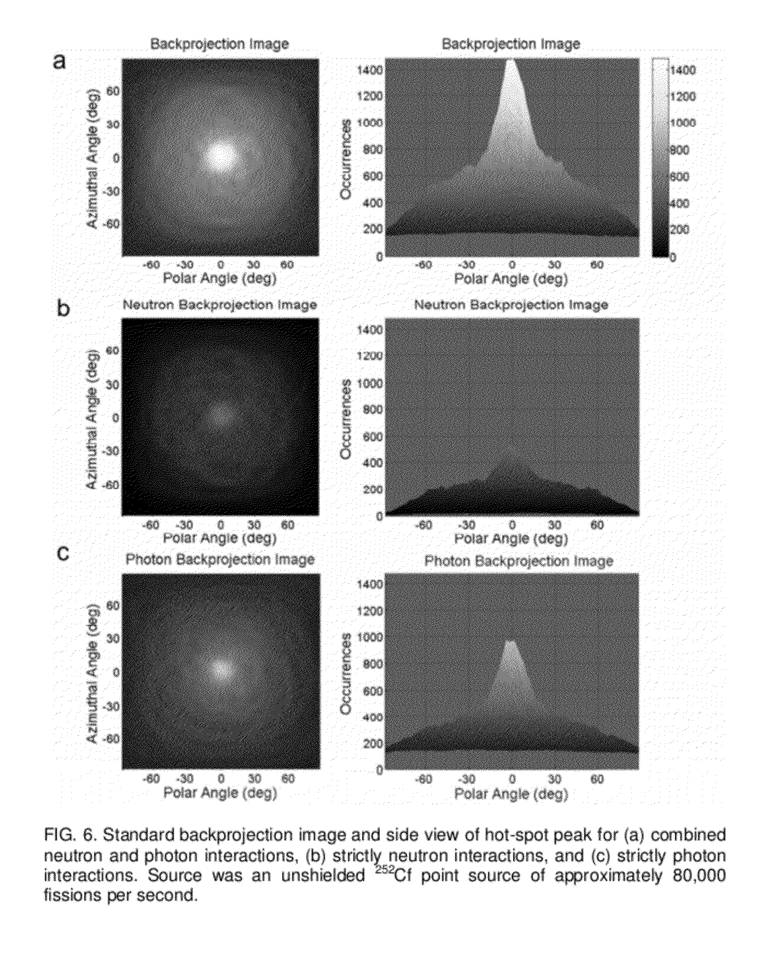

FIG. 6a illustrates the simple-backprojection image for the unshielded case using data from both photons and neutrons. It should be noted that simple-backprojection imaging is a worst case scenario and source localization can be significantly improved using more advanced imaging algorithms such as MLEM. The side-view of the image is also shown to give a perspective on the angular resolution of the peak. FIGS. 6b and 6c show the same two images using strictly neutron interactions and strictly photon interactions, respectively.

FIG. 6 shows a source hot-spot where it is expected to be, directly in front of the system. Additionally, the separate images show the photons account for a majority of the unshielded image.

C. Shielded Cf Point Source

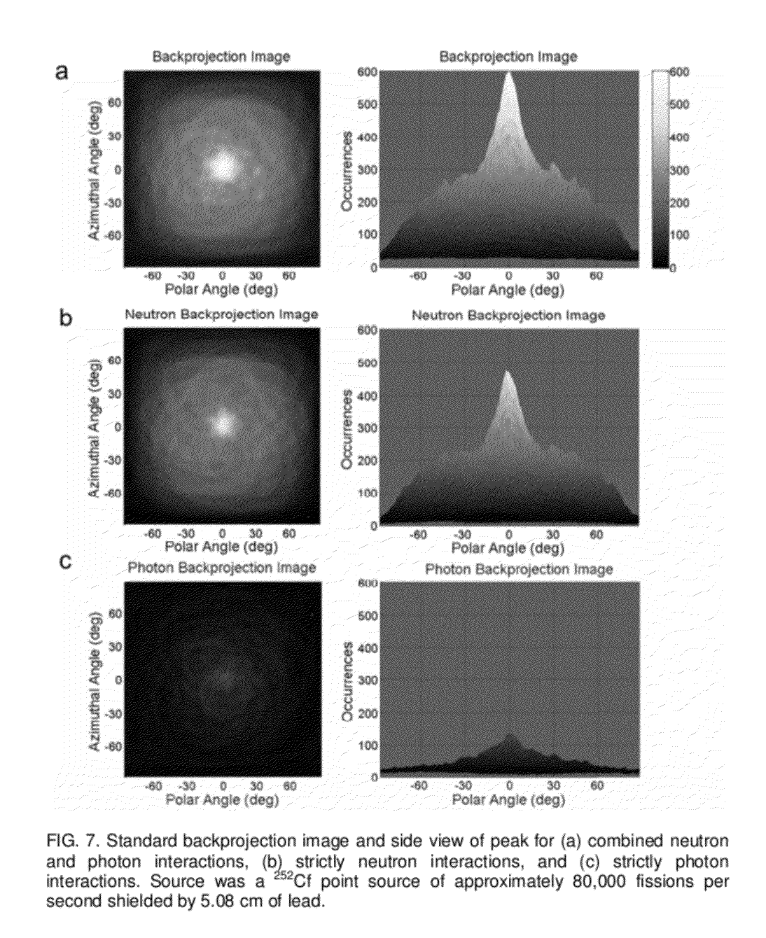

FIGS. 7 to 9 show the same images as FIG. 6 using the data gathered from each of the three shielding cases.

The lead-shielded case is shown in FIG. 7. The location of the source is still clear in the image; however the neutrons have now contributed significantly more counts than the photons due to the presence of the lead shielding.

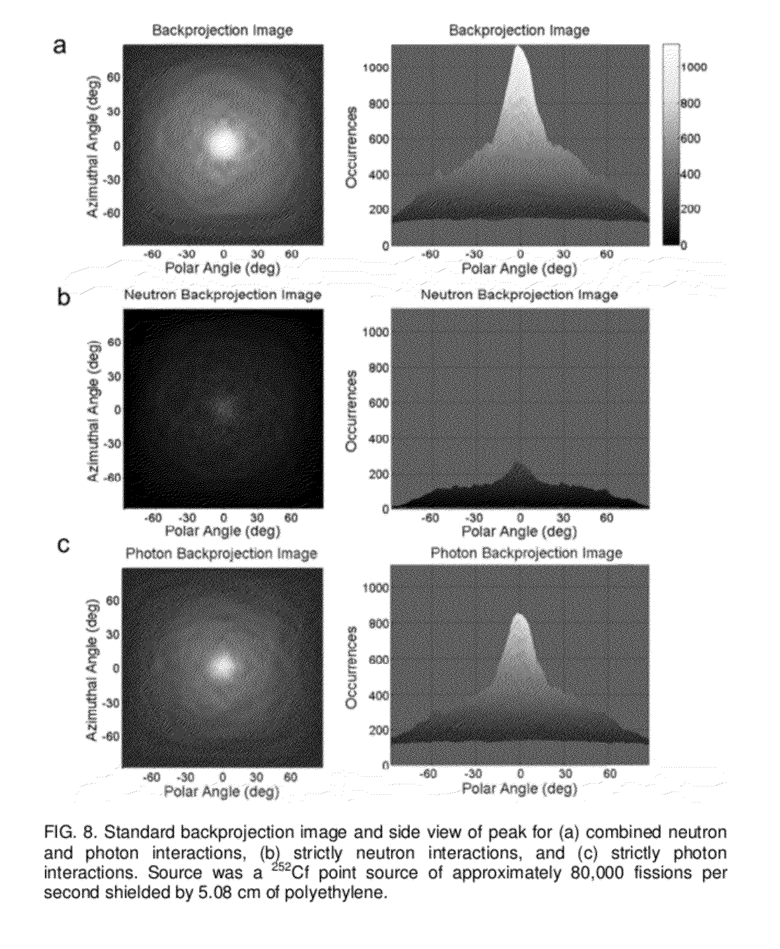

FIG. 8 shows the simple-backprojection data for the polyethylene-shielded case. Once again, it is possible to determine the location of the source using only the simple-backprojection data. As expected, the photons contribute most of the data in the presence of polyethylene shielding.

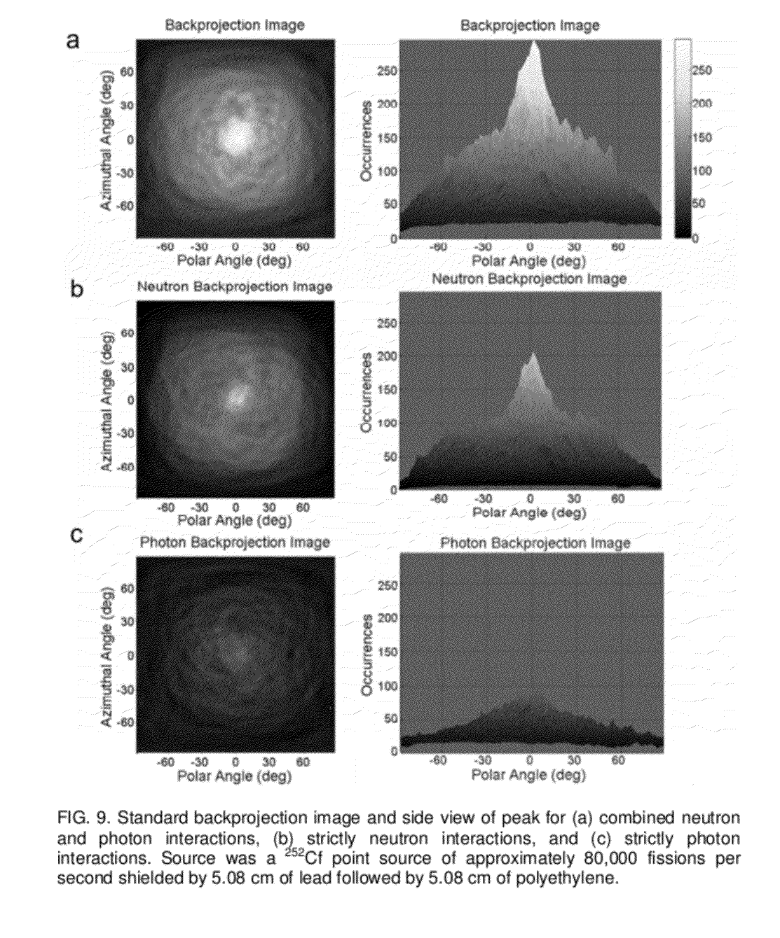

Finally, FIG. 9 depicts the images for the ²⁵²Cf point source shielded by concentric 5.08-cm thick spheres of polyethylene and lead. The direction of the source is still clear despite the presence of 10.16 cm of total shielding. Additionally, neutrons are a more significant contributing factor to the overall image than photons. FIG. 9 especially highlights the theme demonstrated by FIGS. 6 to 9, which is that the combination of photon and neutron data can be very beneficial when trying to detect sources in the presence of various types of shielding.

IV. Validation Measurements

In order to verify the accuracy of the data post-processor, a small Compton camera and a small neutron-scatter camera were constructed using components from the dual-particle imaging system 10. These small systems were then modeled using MCNPX-PoIiMi and the measured data was compared to the simulated and post-processed data.

A. Neutron Validation Measurements

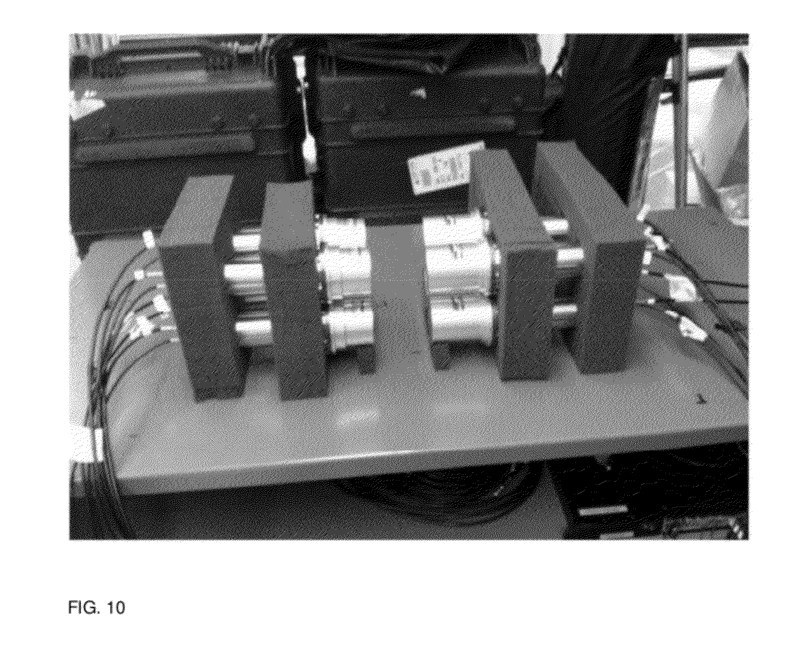

The neutron-scatter camera was set up using two 2×2 planes of EJ-309 liquid scintillators. The front plane consisted of the 5.08-cm thick detectors while the backplane used the 7.62-cm thick detectors. Both planes utilized the ETL 9821 PMTs and the front plane PMTs faced forward while the backplane PMTs faced backward. Additionally, there was a 10-cm spacing between the two detector planes. This setup is shown in FIG. 10.

A ²⁵²Cf source with a spontaneous fission rate of approximately 11,000 fissions per second was located 50 cm from the active material in the first plane with no angular offset from the centerline of the detector planes. Data were collected for two hours. In the measurement, an energy threshold of 70 keVee (which corresponds to a neutron energy deposition of approximately 500 keV) was set using a CAEN V1720 digitizer. This threshold value was matched in the simulation using the post-processor.

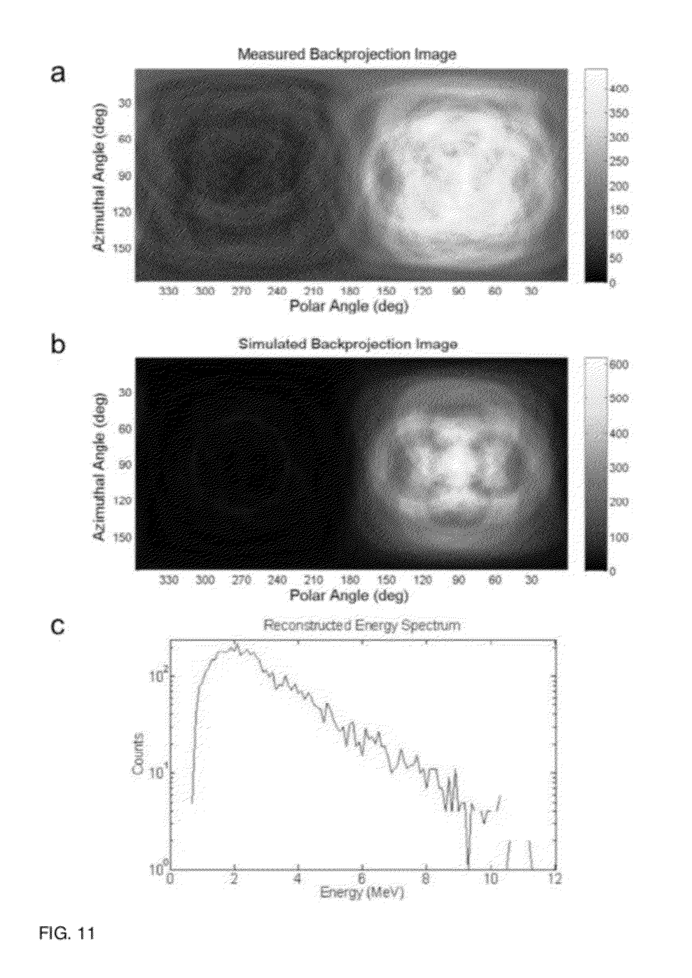

FIGS. 11a and 11b show the comparison between the measured simple-backprojection image and the simulated simple-backprojection image. In both cases, a subtle hot spot can be seen directly in front of the system. Additionally, similar imaging artifacts can be seen in both the measured and simulated data. This concentrated “cloverleaf’ pattern is due to the limited number of possible scatter angles in a two-plane, eight-detector imaging system. It should also be noted that the simulated data do not include background radiation while the measured data do, which is why counts appear in all directions. FIG. 11c shows the reconstructed neutron energy spectrum from the measured data. The reconstructed spectrum has an average energy of approximately 3 MeV, which is higher than the ²⁵²Cf average energy of 2.1 MeV. This is a result of accepting only time-correlated energy depositions (correlated counts) above the energy threshold.

B. Photon Validation Measurements

The Compton camera was set up using two 2×2 detector planes. The front plane consisted of 7.6-cm thick EJ-309 detectors coupled with ETL 9821 PMTs while the back plane consisted of 7.6-cm thick NaI scintillators coupled with ETL 9305 PMTs. There was a 10-cm spacing between detector planes and the PMTs were oriented similar to the neutron-scatter camera.

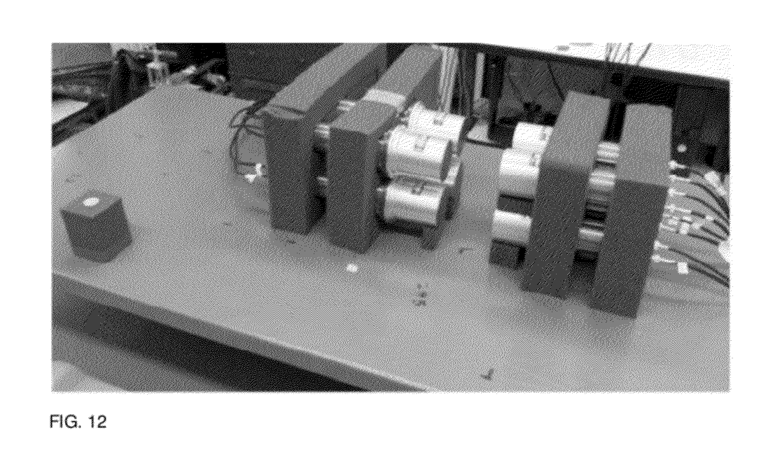

A 30-uCi (3×10⁶ photons per second) ²²Na source was located 50 cm from of the active material and was offset 30 cm horizontally from the center axis of the detector planes. This setup is shown in FIG. 12. Data were collected for 20 minutes using a CAEN V1720 digitizer. A detection threshold of 10 keVee was used in the EJ-309 liquid scintillators and a 70 keVee threshold was used in the NaI scintillators.

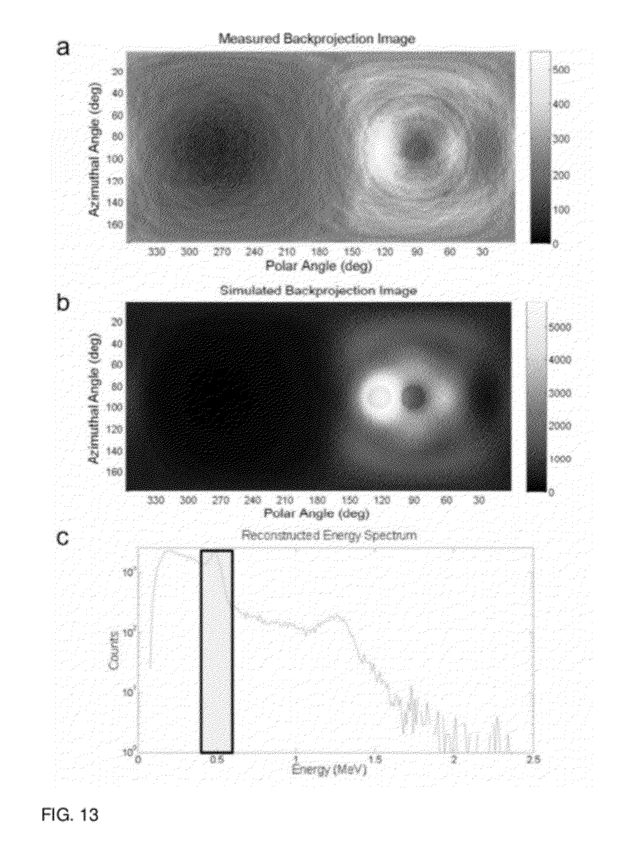

FIGS. 13a and 13b show the comparison between the measured simple-backprojection image and the simulated simple-backprojection image. A hot-spot can be seen in both images at a horizontal offset that corresponds closely to the actual 30 cm offset. Similar to the neutron-scatter-camera images, artifacts have been introduced into the images due to the small number of possible scattering angles. FIG. 13c shows the reconstructed photon energy spectrum generated using the measurement data. The spectrum shows a peak in the vicinity of both 511 keV and 1274 keV, which is expected from a ²²Na source. The shaded region of the energy spectrum shows the energy range that was used to generate the simple-backprojection images seen in FIGS. 13a and 13b.

V. Summary

A three-plane, dual-particle imaging system was developed and disclosed herein for the detection and imaging of SNM. In some embodiments, the system uses two planes of EJ-309 liquid scintillators to scatter photons and neutrons and a third plane of NaI scintillators to preferentially absorb photons. The combination of photon and neutron data allows for more accurate detection and localization of SNM in the presence of shielding than the imaging systems sensitive to a single particle type. A post-processing algorithm was developed that is capable of correlating and reconstructing imageable events using data generated from either a measurement or a simulation.

Validation measurements have been performed using small neutron-scatter and Compton cameras. These validation measurements show reasonable agreement between measured and simulated data. To further validate the system, the measurement capabilities could be scaled to allow all 48 detectors to be used. This would allow for three 16-detector planes and increases measurement efficiency and spatial resolution. Additionally, more advanced image reconstruction techniques, such as maximum likelihood expectation maximization, can be implemented to further improve source localization in comparison to simple-backprojection imaging.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A detection system for detecting and imaging particles from a source, said detection system comprising:
a first plane detecting a first particle contacting therewith and scattering said first particle, said first plane determining a first energy deposition of said first particle and a first time of contact with said first plane;
a second plane detecting said first particle contacting therewith being scattered from said first plane, said second plane determining a second energy deposition of said first particle and a second time of contact with said second plane; and
an actuation system coupled with at least one of said first plane and said second plane, said actuation system physically actuating a physical parameter of said at least one of said first plane and said second plane to effect at least one of said first energy deposition and said second energy deposition.

2. The detection system according to claim 1, further comprising:
a third plane detecting absorption of said first particle outputting absorption data.

3. The detection system according to claim 2, further comprising:
a central processor receiving data including said first energy deposition, said first time of contact, said second energy deposition, said second time of contact, and said absorption data, said central processor analyzing at least some of said data to determine a position of the source.

4. The detection system according to claim 3 wherein said central processor further outputs a control signal to said actuation system to actuated said physical parameter of said at least one of said first plane and said second plane.

5. The detection system according to claim 1 wherein said first plane comprises a liquid scintillator.

6. The detection system according to claim 2 wherein said third plane is a NaI scintillator.

7. The detection system according to claim 1 wherein said actuation system is actively actuated in real time in response to a measured result of at least one of said first energy deposition and said second energy deposition.

8. The detection system according to claim 1 wherein said physical parameter is an inter-planar spacing distance (d) between said first plane and said second plane.

9. The detection system according to claim 1 wherein said physical parameter is an inter-group spacing (s) within said second plane.

10. The detection system according to claim 1 wherein said physical parameter is a detector pitch (t) between adjacent detectors of at least one of said first plane and said second plane.

11. The detection system according to claim 1 wherein said physical parameter is an orientation angle of at least one of said first plane and said second plane.

12. A detection system for detecting and imaging both neutrons and photons from a source, said detection system comprising:
a first plane detecting a plurality of particles contacting therewith and scattering said plurality of particles, said first plane determining a first energy deposition of each of said plurality of particles and a first time of contact of each of said plurality of particles with said first plane, at least one of said plurality of particles is a neutron and at least another of said plurality of particles is a photon such that said first plane detects both neutrons and photons;
a second plane detecting contact of said plurality of particles therewith being scattered from said first plane, said second plane determining a second energy deposition of each of said plurality of particles and a second time of contact of each of said plurality of particles with said second plane; and
an actuation system coupled with at least one of said first plane and said second plane, said actuation system physically actuating a physical parameter of said at least one of said first plane and said second plane to effect at least one of said first energy depositions and said second energy depositions.

13. The detection system according to claim 12, further comprising:
a third plane detecting absorption of at least some of said plurality of particles thereby outputting absorption data.

14. The detection system according to claim 13, further comprising:
a central processor receiving data including said first energy deposition, said first time of contact, said second energy deposition, said second time of contact, and said absorption data for each of the plurality of particles, said central processor analyzing at least some of said data to determine a position of the source.

15. The detection system according to claim 14 wherein said central processor further outputs a control signal to said actuation system to actuated said physical parameter of said at least one of said first plane and said second plane.

16. The detection system according to claim 12 wherein said actuation system is actively actuated in real time in response to a measured result of at least one of said first energy deposition and said second energy deposition.

17. The detection system according to claim 12 wherein said physical parameter is an inter-planar spacing (d) distance between said first plane and said second plane.

18. The detection system according to claim 12 wherein said physical parameter is an inter-group spacing (s) within said second plane.

19. The detection system according to claim 12 wherein said physical parameter is a detector pitch (t) between adjacent detectors of at least one of said first plane and said second plane.

20. The detection system according to claim 12 wherein said physical parameter is an orientation angle of at least one of said first plane and said second plane.
